(19) United States
(12) Patent Application Publication
(10) Pub. No.: US 2015/0309163 A1
(43) Pub. Date: Oct. 29, 2015

(54) VEHICLE

(71) Applicant: PHYCO TRADING B.V., Nijkerk (NL)

(72) Inventors: Kornelis Jan VAN DER VELDE, Dalfsen (NL); Jasper Jeroen RIJNSBURGER, Zwolle (NL)

(21) Appl. No.: 14/647,962

(22) PCT Filed: Nov. 28, 2013
(86) PCT No.: PCT/NL2013/050858

§ 371 Date: May 28, 2015

(30) Foreign Application Priority Data
Nov. 29, 2012 (NL) 2009901

(51) Int. Cl. G01S 7/495; G01S 7/481; B60R 16/023

(52) U.S. Cl. CPC G01S 7/495; B60R 16/0239; G01S 7/4818; G01S 7/4813

(57) ABSTRACT

A vehicle, provided with: at least an optical passage situated at a vehicle exterior for passing on optical signals; a number of elongate optical signal guides, extending between said passage and at least an optical signal processing unit situated in the vehicle, wherein the optical processing unit is provided with a transmitter for transmission of diverging optical signals; wherein an optical system is arranged to pass on light between the signal processing unit and proximal ends of at least a number of the optical signal guides, wherein the optical system comprises a collimator to collimate optical signals coming from the transmitter.

An aspect of the invention relates to a vehicle.

The non-prepublished Netherlands application NL2006876, in applicant's name, describes a vehicle, provided with:

at least an optical passage situated at a vehicle exterior for passing on optical signals;

at least an elongate optical signal guide, extending between the passage and at least an optical signal processing unit situated in the vehicle.

The vehicle can comprise, for instance, a system for detecting optical signals from a vehicle speed monitor (e.g., a laser gun), whereby laser pulses can be sent back to jam the speed monitor.

Examples of laser transponders are described in, for instance, U.S. Pat. No. 5,793,476 (Laakman et al.), for instance, a laser transponder developed by the company Lidatek. The known transponder is arranged to be placed on the front of a vehicle, to detect incoming optical signals (for instance, coming from a speed monitor) and to send back jamming signals. For determining the optical jamming signals, a large number of different methods are known, for instance, transmission of a fixed pattern (independent of the incoming signals), or transmission of jamming signals specifically depending on observed signals.

One of the disadvantages of the known system is that installation as such is relatively difficult. In addition, it is usually hard to find a suitable location for the transponder. Thus, such a transponder is typically to be mounted on a vehicle front and/or rear side, such that it can properly receive incoming signals, and to send jamming signals back in a suitable direction. Moreover, it is then relatively difficult to fit the transponder in a manner that does not impair the look of the vehicle. Moreover, the installed transponder can easily get damaged by objects entering during use, and is subject to rain and wind.

It appears that use of a single transponder does not always lead to good results. Thus, particular vehicle speed monitors irradiate only a relatively small part of a vehicle. For this reason it has been proposed in known systems to provide a vehicle on the outside with different transponders at different locations, in order that incoming signals can be detected at different locations. That is a relatively costly solution, and augments the above-mentioned problems. Further, use of different transponders set up at a distance from each other entails a considerable increase of the use of electrical cabling to couple the various components mutually, which increases susceptibility to malfunction.

The present invention contemplates solving the above-mentioned problems. In particular, the invention contemplates an improved vehicle. According to a further aspect, the invention contemplates a vehicle provided with a reliable and durable optical system which can be installed relatively simply, which consists of relatively few parts, which can be supplied in a cost-wise relatively favorable manner, and suffers from relatively little power loss (concerning signal transmission).

A vehicle according to the invention is characterized by the features of claim 1. The vehicle is provided with:

at least an optical passage situated at a vehicle exterior for passing on optical signals;

a number of elongate optical signal guides, extending between the passage and at least an optical signal processing unit situated in the vehicle,

wherein the optical processing unit is provided with a transmitter for transmission of diverging optical signals;

wherein an optical system is arranged to pass on light between the signal processing unit and proximal ends of at least a number of the optical signal guides, wherein the optical system comprises a collimator to collimate optical signals coming from the transmitter.

In this manner, with relatively few means, light can be coupled into a number of elongate signal guides of the vehicle, in a reliable and effective manner. In particular, thus, a relatively large part of the light emitted by the transmitter can be efficiently launched into a number of (for instance, several) elongate signal guides, to be sent to one or more of the optical passages for radiation to surroundings of the vehicle.

Furthermore, in this manner, a transmitter can be used which has a relatively small transmitting power, for instance, a laser diode, to yet radiate relatively strong, concentrated light signals via a number of exits (i.e., one or more optical passages).

According to a further elaboration, an optical exit of the transmitter may be positioned in or near a focus of the collimator. The positioning of collimator and transmitter is, in particular, such that the diverging signals transmitted by the transmitter are collimated by the collimator into parallel optical signals. The optical signals transmissible by the transmitter can comprise, for instance, a diverging light beam.

According to a further elaboration, the optical system comprises an array of optical elements, to divide signals collimated by the collimator into partial signals (in particular, partial beams), and to pass on the partial signals to the proximal ends of the optical signal guides.

The optical system can be made of particular compact design, which facilitates building it into the vehicle, whereby signal transmission losses can be limited. The array of optical elements can comprise, in particular, an array of microlenses, in particular, lenses—each—having a maximum diameter of 1 cm, in particular 0.5 cm. According to a further elaboration, the array of optical elements may be manufactured of plastic. In particular, the optical elements may be disposed near or against each other, and within a radius of at most 5 cm from an optical axis of the optical system, in particular a radius of at most 2 cm, for instance, a radius of at most 1 cm. According to a further elaboration, the proximal ends of the optical signal guides may, for instance, be positioned in or near foci of the array of microlenses, to effect a proper coupling in of light.

According to an aspect of the invention, the optical processing unit is provided with at least a receiver for reception of optical signals passed on by at least a number of the signal guides. In an embodiment, for instance, the same signal guide can be used for transmission of signals transmitted by the transmitter to an optical passage situated near a vehicle exterior, and for transmission of incoming optical signals from a such passage to the receiver. Alternatively, optical signals to be transmitted from the vehicle and optical signals incident on the vehicle may be guided through the vehicle via different signal guides.

In a further, efficient and relatively compact elaboration, the vehicle is provided with an optical system to pass on light coming from proximal ends of the optical signal guides to the receiver, the optical system comprising an (in particular, second) collimator to collimate optical signals coming from optical signal guides. The optical system may further comprise, in particular, a focusing element, to focus the optical signals collimated by the second collimator on the detector, to increase detection accuracy.

It is then extra advantageous if the second collimator comprises an array of optical collimating elements. Further, the optical system can comprise a semi-transmissive beam splitter, preferably disposed between the second collimator and the proximal ends of the signal guides, arranged for deflecting optical signals coming from the signal guides. A relatively simple, inexpensive implementation of the beam splitter comprises a (transparent) glass plate.

According to a further elaboration, during use, the vehicle may, for instance, only receive one or more optical signals via an optical passage and respective elongate signal guide, or only transmit one or more optical signals via an optical passage and the signal guide, or both receive and transmit one or more optical signals via the passage and guide. The optical signals can then serve various purposes, for instance, determination of a distance between the vehicle and an object situated in surroundings of the vehicle, a measurement of the speed of the vehicle itself (for instance, utilizing a series of the distance determinations mentioned), jamming of an external vehicle speed monitor, remote control of, for instance, a gate or garage door, or a combination of these or other applications.

According to a further elaboration, each signal guide is an elongate flexible signal guide. Such a signal guide can be simply installed, and be laid out along a suitable path in the vehicle. Preferably, the guides are placed in the vehicle in a simple manner, whereby they are fed through via existing openings in the vehicle (for instance, between different compartments in the vehicle).

The signal guide can be made of relatively thin design, for instance, with a maximum outer dimension (e.g., diameter) of not more than 3 cm, in particular at most 2 cm or less, for instance, about 16 mm, and preferably less than 10 mm, for instance, about 5 mm. The signal guide can comprise, for instance, at least an optical fiber (e.g., a glass fiber). The signal guide can be relatively long, preferably having a length of more than about 0.5 m, for instance, at least about 1 m. In addition, a signal guide can have, for instance, a length of less than about 0.5 m, for instance, a length of at least one cm.

The optical passage, which is situated, for instance, in an exterior of the vehicle, may be implemented in different manners. The optical passage can comprise, for instance, an opening, or a window which is provided with a light transmissive material, or may be configured otherwise. A maximum cross dimension of the optical passage can be, for instance, less than 5 mm, so that the passage is hardly visible from surroundings of the vehicle. For that matter, an optical passage can also have a different dimension, having, for instance, a greater maximum cross dimension. The optical passage can comprise, for instance, at least a part of a gap or opening in an exterior of the vehicle, for instance, a gap or opening between neighboring vehicle parts, for example, body parts, lighting, number plate, bumper, air passage(s) and/or other components.

The vehicle may be provided, for instance, with at least two optical passages, for instance, at a mutual distance of more than about 10 cm. In that case, at least two respective elongate signal guides may be provided for transmission of optical signals to and/or from each of these passages.

One or more of such passages may be situated, for instance, at a front side, viewed in a main driving direction, of the vehicle, to transmit optical signals to an area in front of the vehicle and/or receive optical signals therefrom. Further, one or more passages may be situated on a rear side (viewed in the main driving direction) of the vehicle, for exchange of optical signals with an area behind the vehicle. In addition, one or more passages may be situated on one or both sides of the vehicle.

According to an extra advantageous elaboration, the optical passage is provided with an aperture angle adapter which is arranged to provide a horizontal aperture angle that is greater than a vertical aperture angle. In this manner, an optimum field of view can be afforded for the purpose of transmission and detection of signals, whereby an undesired large signal power spread (as transmission in undesired directions) can be efficiently avoided. The aperture angle adapter can comprise, for instance, a biconical lens.

The optical processing unit mentioned may be set up at a suitable location in the vehicle, for instance, in or near a passenger space, in an engine compartment, under a hood, and in any case preferably at a relatively great distance from an optical passage. The processing unit can thus be arranged in the vehicle, at a suitable, safe location. Moreover, in this manner, such a component can be prevented from disturbing the look of the vehicle. The optical signal guide can optically transfer optical signals between the processing unit and optical passage, so that use of possible electrical cabling is avoided or limited to a considerable extent. This leads to a particularly trouble-free operation.

The optical processing unit may in itself be implemented in different manners, depending, for instance, on the desired application or applications. Thus, the optical processing unit may be provided with at least a receiver for reception of optical signals (coming in via a respective passage) passed on by a signal guide. An optical processing unit may be provided with at least the transmitter to transmit optical signals via a signal guide, utilizing the optical system. An extra advantageous transmitter comprises a laser. More particularly, at least an optical processing unit may be provided, which is provided with one or more light signal transmitters as well as one or more light signal receivers. Further, the optical processing unit may, for instance, be provided with a housing, which has one or more optical terminal ports to connect the one or more optical signal guides, the optical system being preferably included in the housing.

According to a further elaboration, the optical processing unit includes at least a data processor, arranged for processing data that are related to the optical signals. Such a data processor may be configured, for instance, to cooperate with an above-mentioned transmitter and/or receiver for the purpose of transmission and/or reception of optical signals.

The data processor may be arranged to process signals that are related to optical measuring signals of a vehicle speed monitor, which optical measuring signals have been received by the vehicle via at least an optical passage as mentioned.

The data processor may be arranged to use the optical signals for measuring or estimating at least a distance between the vehicle and an object situated in surroundings of the vehicle.

According to a further elaboration, the data processor may be arranged to process data with utilization of a neural network, for instance to thereby provide a self-learning data processor which during use adjusts data processing in each case on the basis of at least a preceding data processing.

According to a further elaboration, the data processor of the system is arranged to process signals that are related to optical measuring signals from a vehicle speed monitor, detected by a receiver. In that case, the data processor may be configured, for instance, to control the transmitter such that jamming signals are transmitted with it, to jam the speed monitor.

In addition, the data processor may be arranged, for instance, to use the signal guides, the transmitter and a receiver in a distance measurement, for instance, to provide parking assistance. To this end, for instance, the transmitter may be driven by the data processor to transmit at least an optical measuring signal, this measuring signal being radiated from the vehicle to a nearby object. A receiver can be used to receive a reflection of the transmitted measuring signal, coming from the object. Then, the distance to the object can be simply determined or estimated by the data processor, at least, by measurement or estimation of the time period between transmission and reception of measuring signal and reflection, and, for instance, a distance-dependent signal can be delivered.

Further, an aspect of the invention provides a set, comprising a number of elongate optical signal guides, an optical processing unit and an optical system, apparently intended and suitable for use in a vehicle according to the invention. Such a set may be supplied separately from a vehicle, in order to be built into the vehicle so as to afford to it the advantages of the invention.

Further advantageous elaborations of the invention are described in the subclaims. Now, the invention will be clarified on the basis of non-limiting exemplary embodiments and the drawings. In the drawings:

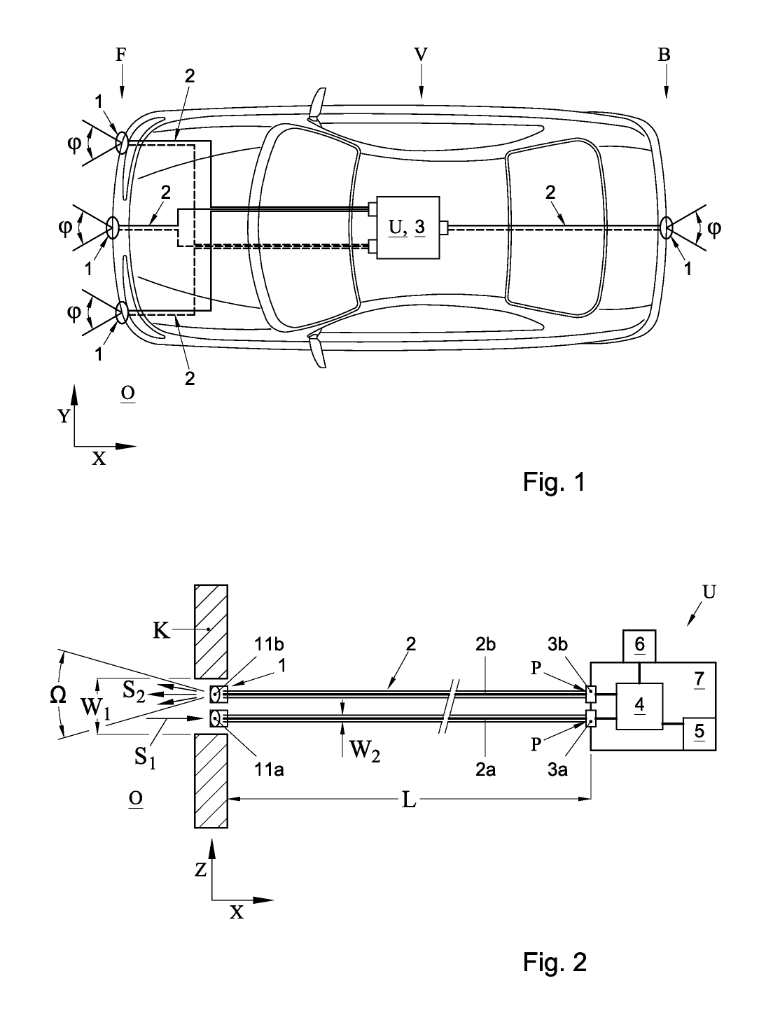

FIG. 1 schematically shows a vehicle according to an exemplary embodiment of the invention, in top plan view;

FIG. 2 shows a part of the vehicle represented in FIG. 1 in more detail, schematically in a side view;

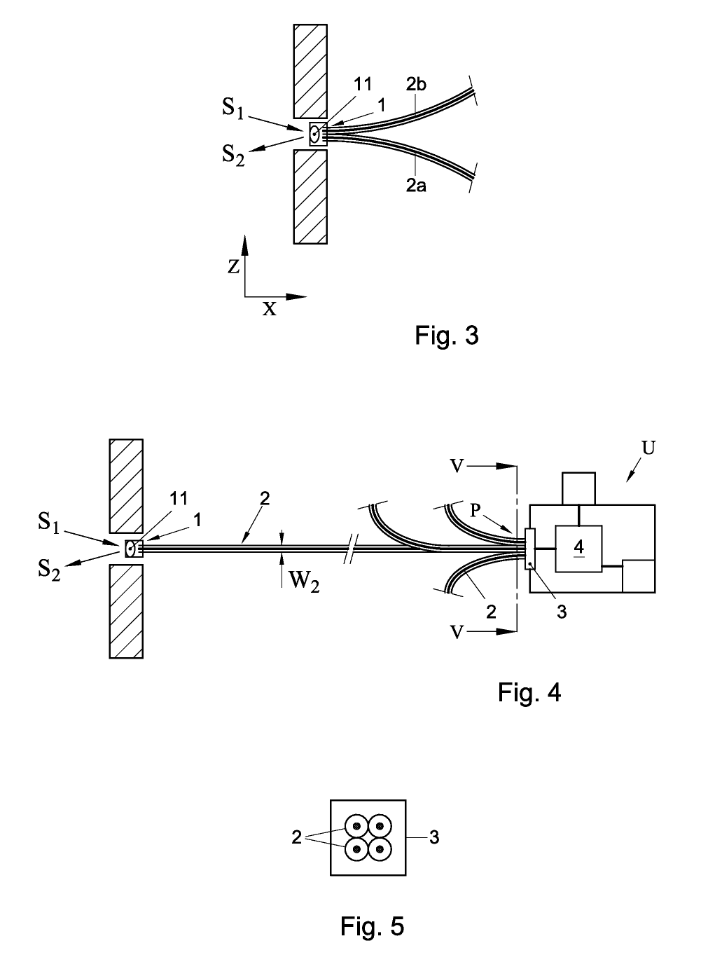

FIG. 3 shows an alternative elaboration of a part of the vehicle;

FIG. 4 shows a further alternative elaboration of the vehicle;

FIG. 5 shows a cross sectional view along line V-V of FIG. 4;

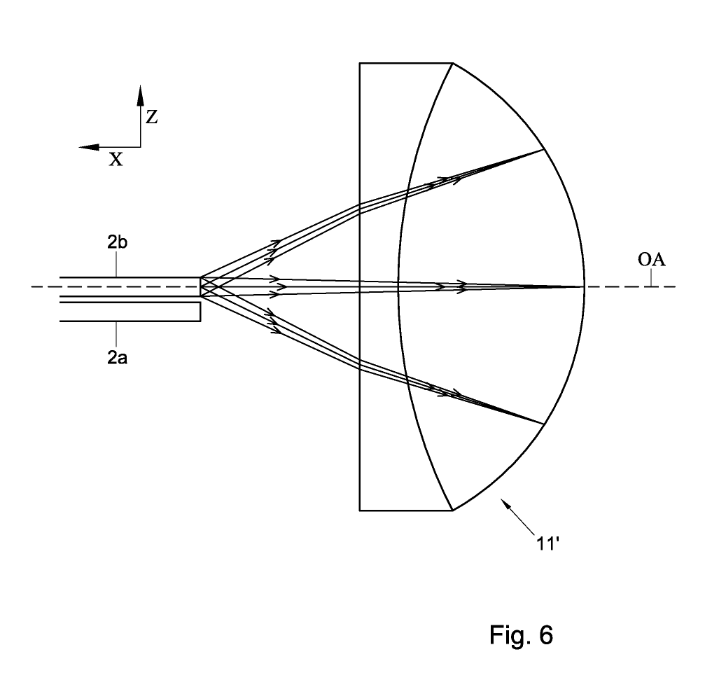

FIG. 6 shows an alternative elaboration of a part of the vehicle, schematically in a side view;

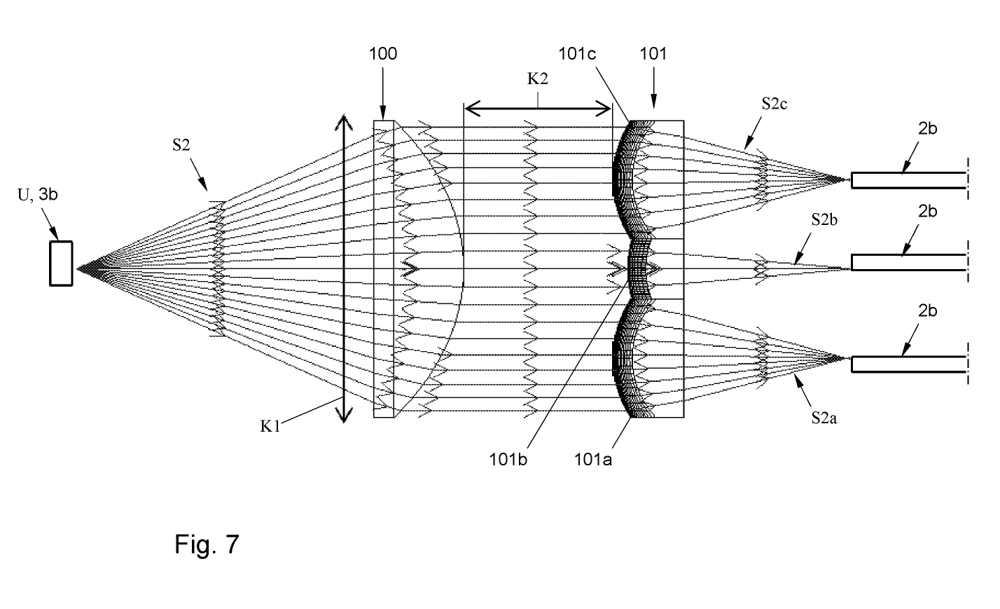

FIG. 7 shows a first exemplary embodiment of an optical system of the vehicle;

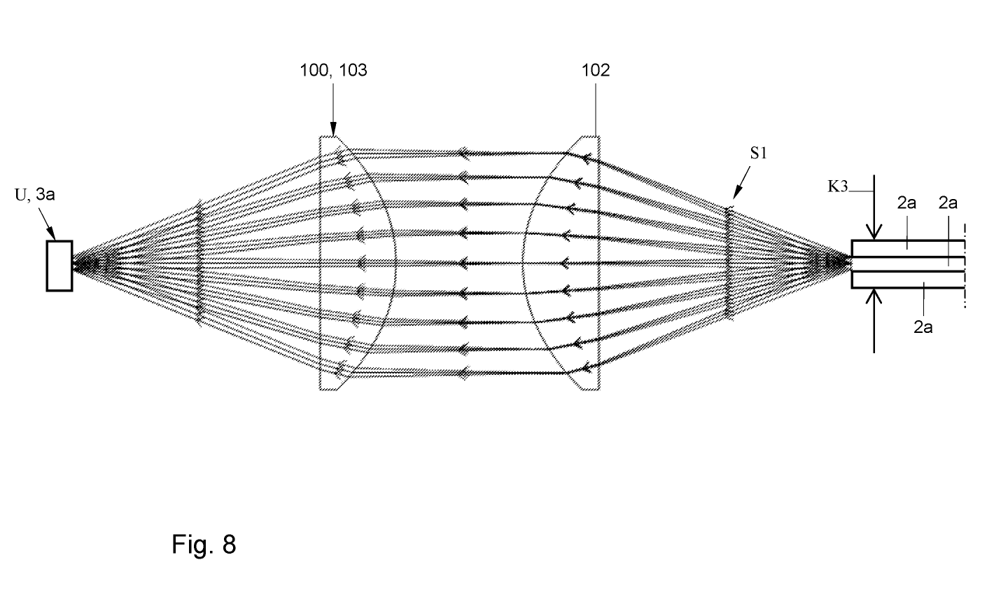

FIG. 8 shows a second exemplary embodiment of an optical system of the vehicle; and

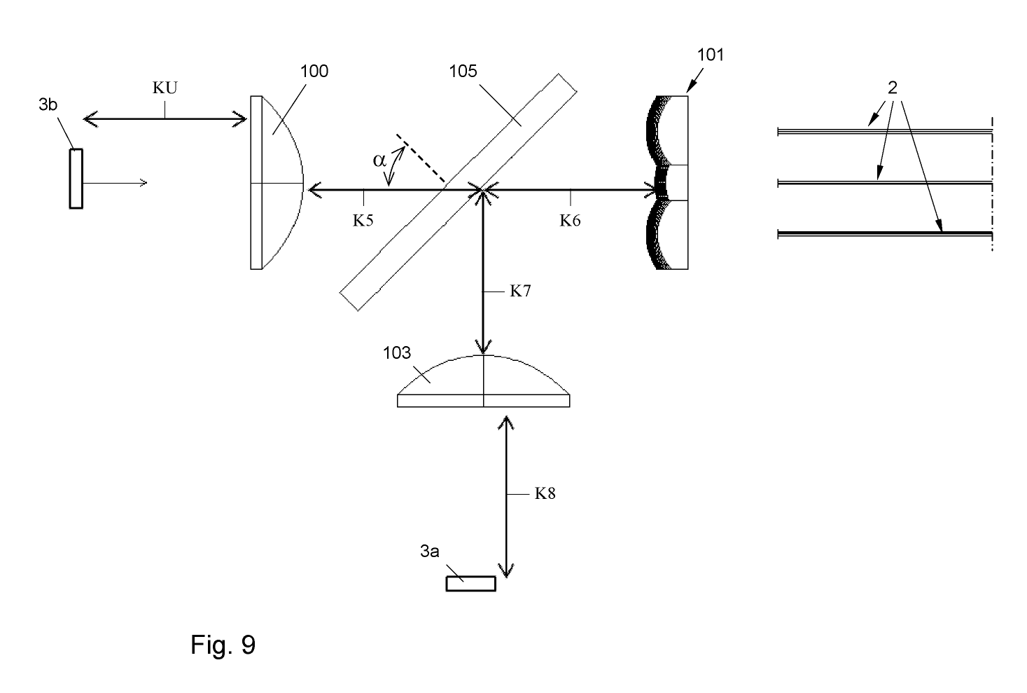

FIG. 9 shows a third exemplary embodiment of an optical system of the vehicle.

Like or corresponding features are indicated in this application with like or corresponding reference signs. In FIGS. 1, 2, 3, 6, three orthonormal directions are indicated with arrows X, Y, and Z.

FIG. 1 shows a vehicle V, provided with optical passages 1 (for instance, entrance and/or exit windows), situated at (i.e., in) a vehicle exterior, for passing on optical signals S1, S2 (into and/or out of the vehicle). Further, the vehicle is provided with elongate optical signal guides 2, which extend between the passage 1 and an (in this case only one) optical signal processing unit U situated in the vehicle. In this non-limitative example, the signal guides 2 and signal processing unit U form an optical system for reception and transmission of optical signals S1, S2. The system has already been built into the vehicle V here; the schematic drawing in FIG. 1 is partly cutaway to make the built-in system visible. FIG. 2 shows an example of the system 2, U in more detail.

In FIG. 1 the optical passages 1 are drawn in schematically and comparatively large. In practice, one or more of these passages 1 can be relatively small with respect to the vehicle. Hereinabove, examples of suitable locations of such a passage have been mentioned, in particular, for instance, at least a part of a gap or opening in an exterior of the vehicle.

According to an aspect, it is advantageous if minimally one optical passage 1 (for transmission and reception of signals) is provided at the front side of the vehicle. In addition, it is advantageous if minimally one optical passage 1 (for transmission and reception of signals) is provided at the rear side of the vehicle.

Given use of only one optical passage 1 at the front side, that passage 1 should preferably be situated centrally of (i.e., in or near the middle of the vehicle, viewed in a top plan view of the vehicle, for instance, in a bumper or vehicle license number.

Given use of two optical passages 1 at the vehicle front side, it is preferred that these passages be situated at about 1 meter+/−0.5 meter distance (measured in horizontal direction) from each other, in particular about 0.5 meter+/−0.25 meter, for instance, symmetrically in a bumper, or otherwise near either side of a license number of the vehicle.

Given use of three optical passages 1 on the vehicle front side, it is preferred that these passages be arranged at about 0.5 meter+/−0.25 meter distance (measured in horizontal direction) from each other, for instance, symmetrically in a vehicle bumper, or otherwise near a license plate and headlights.

Given use of only one optical passage 1 at the vehicle rear side, that passage 1 should preferably be situated centrally of (i.e., in or near the middle of) the vehicle, viewed in a top plan view of the vehicle, for instance, in a bumper or vehicle license number.

Given use of two optical passages 1 on the vehicle rear side, it is preferred that these passages be situated at about 1 meter+/−0.5 meter distance (measured in horizontal direction) from each other, in particular about 0.5 meter+/−0.25 meter, for instance, symmetrically in a bumper, or otherwise near either side of a license number of the vehicle.

Given use of three optical passages 1 on the vehicle rear side, it is preferred that these passages be arranged at about 0.5 meter+/−0.25 meter distance (measured in horizontal direction) from each other, for instance, symmetrically in a vehicle bumper, or otherwise near a license plate and headlights.

FIG. 2 shows a passage 1 schematically in a cross section, where optical signals incident on the passage from surroundings O are drawn-in with arrow S1, and signals sent out via the passage with arrow S2. The passage 1 extends through a vehicle part K, which defines, for instance, a part of a vehicle exterior. The passage 1 can, for instance, be an opening, or a passage defined by a light-transmissive material (which material, in particular, is substantially transmissive of optical signals S1, S2, for example, glass or a transparent plastic). A passage 1 may be provided with, for instance, a watertight and/or airtight sealing transmissive of the signals S1, S2 (for example, a suitable cap, plate, or stuffing).

In a further elaboration, the vehicle V is already provided with the one or more signal passages 1 when the system 2, U (for reception and transmission of optical signals S1, S2) is built into the vehicle. In addition, one or more of the passages 1 may be provided in the vehicle V specifically for the purpose of allowing optical signals to pass (to/from one or more respective elongate signal guides 2).

According to a further elaboration, a maximum cross dimension W1, for instance, a height or diameter, of an optical passage 1 is about 1 cm or less, for instance, about 5 mm or less. A minimum cross dimension W1 of such a passage can be, for instance, about 1 mm or more. A total surface of at least one of the passages 1 measured in the cross section (i.e., a section normal to a direction X drawn in FIG. 2), for instance, of each signal passage 1, can be, for instance, at most 1 cm², more particularly, for instance, at most 0.25 cm². For instance, an optical passage 1 may further have a length, measured in a direction X normal to a local vehicle exterior, of, for instance, less than 10 cm, for instance, a length in the range of about 1 mm-5 cm, or other length.

In the present example, the vehicle is provided with a number of locations (three, in this example) at a front side F which have optical passages 1, with respective signal guides 2. The vehicle front F is related to the forward main driving direction of the vehicle. A mutual distance between these front passage locations can be, for instance, at least about 10 cm or more. For that matter, it is noted here that these front passages 1 may, for instance, be separated from each other, or be part of, for instance, a gap or opening in the front of the vehicle V. Further, the example is provided with an optical passage 1 at the rear of the vehicle, to receive and/or transmit optical signals there as well, utilizing a respective signal guide 2 and optical signal processor U. Preferably, the vehicle is (further) provided with at least one such optical passage in each side of the vehicle, to receive and/or transmit optical signals at the sides.

A passage 1 for optical signals S1, S2 is associated in each case with one or more elongate, preferably flexible, optical signal guide(s) 2 extending into the vehicle. As FIG. 2 shows, the signal guide 2 may be provided with a first end, near or in the respective passage 1, for reception of ambient signals S1 which are incident on the passage 1 and/or for transmitting signals S2 via the passage 1 to the surroundings O of the vehicle V. Further, the signal guide 2 may be provided with a second end, which is coupled, for instance, to the optical unit U, to exchange optical signals with it.

The signal guides 2 can each, in particular, include at least an optical fiber (e.g., glass fiber), and, for instance, have a length L of more than about 0.5 m, for instance, at least about 1 m. As has already been mentioned, also shorter signal guides 2 can be used, which depends inter alfa on a distance to be bridged by that guide 2 between the optical passage 1 and a processing unit U installed in the vehicle. In this example, the optical signal guides 2 (preferably optical fibers 2) can guide optical signals S1 incident on the vehicle to processing unit U, and transmit signals S2 from processing unit U to the surroundings O. The processing unit U is thus set up at a distance from the optical passage(s) 1, stably and in a safe location in the vehicle. As mentioned, advantageous locations of the unit U include, for example, a passenger space, a dashboard, a central console next to the driver, an engine compartment, under a hood, and the like.

Each signal guide 2 may in itself be implemented in different manners. The signal guide 2 can comprise, for example, a flexible optical cable, provided with one or more optical fibers and a protective sheath. The light guide 2 may be provided with a robust insulation, so as to be suitable for use in an engine compartment of a vehicle V. Preferably, each signal guide 2 is provided with just one central optical fiber so as to present an extra thin configuration, but this is not requisite.

A maximum outside diameter of an optical cable may be, for instance, within the range of about 1 to 30 mm, or of a different size. According to a further elaboration the guide 2 has a maximum outside dimension (e.g., diameter) of about 2 cm or less. One or more of the signal guides 2 may furthermore, for instance, each consist of a bare optical fiber, with a very small outside diameter (for instance, a diameter of about 1 mm or less).

Installation of an optical signal guide 2, in the vehicle V, can be carried out in different manners. Preferably, the guide 2 is fixed to the vehicle at one or more locations through fixing means, for instance, using tape, Velcro, clamping means, cement, and/or the like, such that the guide 2 is durably positioned along a desired path (and preferably at a distance from parts that move during driving).

An end of a signal guide 2 situated at a passage 1 may be coupled to that passage 1, for instance, by means of a suitable connector (not shown), for instance, a signal guide connector extending through the passage 1, a signal guide connector mounted on a nearby vehicle part K, or in a different way.

The present vehicle V is provided with an optical processing unit U, having a housing 7, which, in particular, has at least a receiver 3a for reception of optical signals S1 passed on by one or more of the signal guides 2. In this case the unit U is additionally provided with a transmitter 3b for transmission of optical signals S2 via one or more of the signal guides 2. It is then extra advantageous if the transmitter 3b is arranged to transmit diverging optical signals, in particular diverging infrared optical signals. To this end, the transmitter 3b can comprise a laser diode.

Preferably, the transmitter (e.g., laser diode) is arranged to emit at least about 8 watts light power per signal guide and respective optical passage 1. In particular, the transmitter (e.g., laser diode) may be arranged to emit at least 10 watts peak power per signal guide and respective optical passage 1. Given use of three passages 1 and one transmitter 3b for generating signals S2 to be transmitted via those passages 1, the transmitter can hence provide at least about 3×8=at least about 24 watts power (for instance, at least 30 watts peak power).

The receiver 3a and transmitter 3b can each be implemented in different manners, which will be clear to the skilled person. Thus, an optical receiver 3a can comprise, for example, an image sensor, a photocell and/or may be implemented differently. A transmitter 3b can, in particular, comprise one or more light sources. According to an extra advantageous elaboration, the transmitter 3b comprises a laser, for example, a semiconductor laser (e.g., one or more laser diodes). The transmitter 3b may be arranged to transmit, for example, infrared optical signals S2, at least, signals S2 of which a wavelength is only in the infrared spectrum, or other signals. The wavelength mentioned can be, for instance, in a range of about 850-1000 nm, for example, 905 nm, or other range.

In this example, the receiver 3a may be arranged to detect in any case incoming optical signals S1 having a wavelength that is the same as a wavelength of signals S2 to be transmitted by the transmitter 3b. More particularly, the receiver 3a may be implemented to detect infrared optical signals S1, at least, signals S1 of which a wavelength is in a range of about 850-1000 nm, for example, 905 nm, or other range.

In case a separate receiver 3a and transmitter 3b are used, the processing of optical signal reception and transmission may be carried out, for instance, simultaneously. It is then possible, for instance, to separate the sensitive electronics of the receiver 3a from the electronics of the transmitter 3b, which is of benefit to the sensitivity of the whole.

The transmitter 3b and receiver 3a can jointly form an optical transceiver 3, which is shown in the example according to FIGS. 4-5. Such a transceiver 3 can receive the optical signals S1 coming in via guides 2, and send signals S2 into the guides 2. In case of such a combined transmitter/receiver 3, for instance, a single light guide 2 is used for light transport in both directions. The signals S1, S2 going back and forth are then processed alternately.

According to a further elaboration, the vehicle V is provided with at least two optical signal guides 2, 2a which are associated with one optical receiver 3, 3a, such that optical signals S1 coming in via those signal guides are detectable by that one receiver 3, 3a. Further, the vehicle V may be advantageously provided with at least two optical signal guides 2, 2b which are associated with one optical transmitter 3, 3b, such that optical signals S2 transmitted by that transmitter are transmissible via the at least two optical signal guides 2, 2b.

Thus, FIG. 5 shows a further elaboration, where ends of different signal guides 2 are bundled. Exteriors of the end parts of the guides 2 may, for instance, touch each other, as in the drawing. The transceiver 3 is arranged to receive signals S1 from each of the guides 2 separately, or, at least, to be able to discriminate between the signals S1 incident from the various guides 2. Further, the transceiver 3 may be arranged to transmit, for instance, the same signal S2 via the guides 2, or to transmit mutually different signals S2 via the different guides 2.

It is noted that the setup shown schematically in FIG. 5, with a bundling of ends of signal guides, may also be used in combination with a separate receiver 3a, the receiver 3a then being arranged to discriminate between the signals S1 incident from the various guides 2a.

Analogously, the setup shown schematically in FIG. 5, with a bundling of ends of signal guides, may also be used in combination with a separate transmitter 3b, while the transmitter 3b may be arranged to transmit the same or, conversely, mutually different, signals S2 into the respective guides 2b. According to a further elaboration, for instance, an array of microlenses may be used to couple light coming from one transmitter 3b (e.g., a laser diode) efficiently into different signal guide fibers 2b. According to an extra advantageous embodiment (see also FIGS. 6-8), also at least a collimator may be provided for an efficient signal transfer.

Further, the housing 7 of the optical processing unit U may be provided with one or more optical terminal ports P to connect thereto the one or more optical signal guides 2, for instance detachably. Each terminal port of the housing 7 may be associated with a transmitter 3b and/or receiver 3a (and optionally be part thereof) to transmit and/or receive signals to/from a signal guide 2 connected to that terminal port.

As FIG. 2 and FIG. 3 show in further elaborations, an optical passage 1 may be associated with, for instance, at least a first optical signal guide 2a for passing on received signals S1, and at least a second optical signal guide 2b for passing on signals S2 to be transmitted.

FIG. 4 shows an extra advantageous elaboration, in which an optical passage 1 is associated with a single optical signal guide 2 which serves both for passing on the received optical signals S1 and for passing on optical signals S2 (transmitted by transceiver 3) to be transmitted.

Preferably, one or more optical means are used to enlarge a horizontal aperture angle φ (in particular in connection with reception of optical signals S1) at an optical passage 1. Examples of a horizontal aperture angle are schematically drawn-in in FIG. 1 with angles φ. As follows from the drawing, the horizontal aperture angle φ is measured in the XY plane denoted with arrows, for instance, a horizontal plane, i.e., a plane parallel to a driving direction of the vehicle in a top plan view of the vehicle.

The horizontal aperture angle φ for each of the different passages 1 can be substantially the same angle, or can include mutually different aperture angles. The horizontal aperture angle φ is, in particular, greater than about 10 degrees, more particularly, greater than about 20 degrees, more particularly, at least 30 degrees. The above-mentioned optical means (i.e., an ‘aperture angle adapter’) can comprise, for instance, a reflector and/or a lens, which is/are set up in or near the optical passage 1, such that signals S1 coming in within the desired horizontal aperture angle are thereby led into an end of an optical signal guide 2.

The present figures show, in particular, use of (for instance, positive) lenses 11, 11a set up in/adjacent to the passages 1 to enlarge the above-mentioned horizontal aperture angle φ (and for optical coupling-in of the respective one or more signal guides). A diameter of each lens 11, 11a may be, for instance, equal to or less than an above-mentioned maximum cross dimension W1 of the respective optical passage 1. According to a further elaboration, each lens 11, 11a has a diameter that is in the range of about 1-20 mm, for instance (though not limited to) a diameter that is less than about 5 mm. According to an extra advantageous elaboration, the diameter of such a lens 11, 11a is in the range of 0.7-1.5 cm, for instance, a diameter of about 1 cm.

For that matter, such a lens 11, 11a may be set up at different locations, for instance, in the passage 1, outside thereof (i.e., on a vehicle exterior) or just behind the passage 1 in the vehicle V. Further, for instance, in each case a lens system of at least two lenses may be provided to enlarge the horizontal aperture angle φ. Furthermore, the lens 11, 11a in itself may form a watertight and/or airtight sealing of a respective optical passage 1 (hence without a gap, visible in FIGS. 2-4, between the lens and a vehicle edge/side surrounding the passage). The lens 11, 11a can further afford protection to a signal guide 2 set up behind it.

It is noted that a lens 11, 11a can be chosen per desired situation, in particular as regards an aperture angle and/or diameter. A lens as mentioned can have, for instance, a fixed or variable focal distance.

In addition, in the example, optical means (in this example again lenses 11, 11b) are provided to adapt, for instance, enlarge, the horizontal aperture angle φ of signals S2 to be transmitted via a passage 1.

A vertical aperture angle Ω of, or associated with, the optical passage 1 can, for instance, be equal to the horizontal opening angle φ. With a view to an efficient transmission of signals, the vertical aperture angle Ω is preferably a different angle than the horizontal aperture angle φ. As follows from FIG. 2, the vertical aperture angle Ω is measured in the XZ plane denoted with arrows, for instance, a vertical plane, i.e., a plane parallel to a driving direction of the vehicle in a side view of the vehicle.

According to a further elaboration, the vertical aperture angle Ω, in particular for the purpose of transmission of signals S2, is smaller than the horizontal aperture angle φ for reception of signals S1. To this end, for instance, advantageously, use can be made of a biconical aperture angle adapter 11′, in particular a biconical lens 11′, of which an example is represented in FIG. 6. With such a lens 11′, for instance, an elliptically shaped focus can be obtained, which will be clear to the skilled person. According to an extra advantageous elaboration, the biconical lens 11′ is made from (transparent) plastic, which is favorable from the viewpoint of costs. A vertical aperture angle Ω provided by the biconical aperture angle adapter can be, for instance, at least 5 degrees smaller than the horizontal aperture angle φ, more particularly at least 10 degrees smaller than said horizontal aperture angle φ. According to a further elaboration, a minimum vertical aperture angle Ω is 5 degrees, and in particular at least about 10 degrees.

It will be clear that the means 11, 11a, 11b to adapt the aperture angle/angles φ, Ω may be mounted in different manners.

The means 11, 11a, 11b may, for instance, be positioned at a fixed position with respect to a nearby end of a respective optical signal guide 2, and, for instance, be fixed to the signal guide 2 in a desired position by means of a connection or coupling. According to an extra advantageous elaboration, these means 11, 11a, 11b are already coupled to a respective signal guide 2, or integrated therewith, before the guide 2 is built into the vehicle, thus allowing relatively fast and simple building in.

The example shown in FIG. 2 is provided with separate aperture angle adapters 11a, 11b for the optical guides 2a, 2b for transmission and reception of signals. An extra compact configuration is shown in FIG. 3 and FIG. 6, where an aperture angle adapter 11, 11′ is associated with both a first signal guide 2a (for passing on incoming signals S1) and a second signal guide 2b (for passing on signals S2 to be transmitted).

Preferably, the second signal guide 2b in this case is placed axially symmetrically with respect to the aperture angle adapter 11 (i.e., centrally on an optical axis OA of the aperture angle adapter 11) in order to be able to utilize the exiting beam maximally. This is represented in FIG. 6 in more detail. Further, the first signal guide 2a is preferably placed as closely as possible against (for instance, at the underside of) the second signal guide 2b, in particular with an intermediate distance of less than 1 mm, for instance, 0 mm, in order to capture an incident signal S1 maximally. By placing both a transmission guide and a reception guide 2a, 2b before the same aperture angle adapter 11 (e.g., lens), the number of apertures on the exterior of the vehicle can be minimized.

FIG. 4 shows an example where the same aperture angle adapter 11 serves both for enlargement of the aperture angle for reception of signals S1 and for enlargement of the aperture angle for transmission of signals S2, by being associated with the signal guide 2. In this case, too, use can be made of a biconical aperture angle adapter, to provide mutually different horizontal and vertical aperture angles.

Preferably, one or more optical filters are used to filter received signals S1. Such a filter may, for instance, be part of the optical means 11, 11a, 11b for enlargement of an aperture angle, and/or may be implemented differently. In addition, such a filter may, for instance, be part of a receiver 3a, 3, or be set up between the receiver and a respective signal guide 2a, 2. Further, such a filter may, for instance, be combined with an optional watertight and/or airtight sealing of an optical passage 1. More particularly, such a filter may be arranged to substantially pass light within a predetermined wavelength region, and to substantially not pass light outside of that wavelength region (for instance, to absorb and/or reflect it).

In the examples, the optical processing unit U is provided with a data processor 4, which is arranged for processing data that are related to the optical signals S1, S2. The data comprise, for instance, data generated by a receiver 3a, 3, for instance, electrical measuring signals, concerning reception of the one or more optical signals S1. The data further comprise, for instance, control signals for control of a transmitter 3b, 3, for the purpose of transmission of one or more optical signals S2.

The data processor 4 preferably disposes of information that is related to a length L of the optical signal guide 2, 2a, 2b. Such information can comprise, for instance, the physical length L of the signal guide, or an optical path length of light guided by that guide, or an amount of time it takes light to pass through the guide, or other information. The data processor 4 can use this information with great advantage in the processing of information concerning optical signals S1, S2 to be transmitted and/or received.

In particular, the guide length information may be used by the data processor 4 to accurately determine a moment when a signal S1 was received in the optical passage 1, before the signal S1 was guided by a guide 2, 2a to a receiver 3, 3a. The data processor 4 can apply a first time correction to a detection moment, concerning a detection of the signal S1 carried out by a receiver 3, 3a, which first correction is proportional to the length L of the respective optical signal guide 2, 2a (e.g., a time correction comprising this length L divided by the speed of light). A reception time at the optical passage 1 is then equal to the detection moment at the receiver minus the first time correction.

Similarly, the guide length information can be used by the data processor 4 to accurately determine a moment when a signal S2 is to be transmitted from the optical passage 1, taking into account the time it will take the signal S2 to pass from a transmitter 3, 3b through the signal guide 2, 2b. The data processor 4 can apply a second time correction to a transmission moment, concerning a transmission of the signal S2 carried out by a transmitter 3, 3b, which second correction is proportional to the length L of the respective optical signal guide 2, 2b (e.g., a time correction comprising this length L divided by the speed of light). A transmission time at the optical passage 1 then equals the transmission moment at the transmitter plus the second time correction.

Further, a suitable supply 5 may be provided, for instance to supply the parts of the unit U. The supply 5 can comprise, for instance, a battery supply, an external supply, and/or may be implemented in a different manner. According to a further elaboration, the supply 5 can comprise a supply connection with a relatively ample input voltage range. The unit U may thus be connectible, for instance, to a portable battery, but also to a motorcar accumulator or an external mains voltage adapter, which increases the field of application.

The vehicle may further be provided with a user interface 6, which may be implemented in different manners. The interface 6 may, for instance, be wholly or partly combined with the unit U, or be set up wholly or partly at a distance therefrom and then be coupled to the unit U, for instance, via a suitable wired or wireless connection. The interface 6 may, for instance, comprise a control panel, be provided with touch keys, press keys, utilize voice operation, be provided with a display, for example, a touch sensitive screen, be provided with a data transfer port (for instance, to plug in a data carrier) and/or the like. The interface 6 may, for instance, utilize graphic light symbols and/or acoustic signals to signal a user (in particular, a driver of the vehicle V).

According to an extra particular elaboration, the data processor 4 is arranged to process signals that are related to optical measuring signals S1 of a vehicle speed monitor (itself not represented), which optical measuring signals S1 have been received via at least an optical passage 1. In that case the data processor 4 can, for instance, warn a user that such signals S1 have been received. In addition, the data processor 4 may be arranged, for instance, to transmit jamming signals S2. Optical jamming signals S2 to be transmitted may be composed in different manners, which will be clear to the skilled person. Preferably, jamming signals S2 to be transmitted depend on observed measuring signals S1, such that a good jamming of the monitor can be achieved and, for instance, such that the monitor does not notice that it is being jammed (“stealth”).

In addition, the data processor 4 may be arranged, for instance, to use the optical signals for measuring or estimating at least a distance between the vehicle and an object in the surroundings of the vehicle (e.g., a wall, sidewalk, another vehicle, a person and/or the like). A result of such a measurement/estimate can be passed on via the interface 6 to the driver of the vehicle V. The data processor 4 can thus offer, for instance, a parking assistance function, or be part of an adaptive cruise control system, or both.

Another function to be carried out by the data processor 4 can comprise, for instance, a remote control, for instance, for operation of a gate or garage door. In that case, the data processor 4 is configured to provide for transmission of remote control signals S2 that are suitable to control a unit to be operated (e.g., an actuator to move a gate or door).

Yet another function comprises, for instance, remote control for unlocking the vehicle V, and/or for activation of vehicle accessories. In that case, one or more first signals S1 can be transmitted to the vehicle V by an external remote control, which signals S1 are received via optical passage(s) 1 and signal guide(s) 2, and are detected by the receiver 3. Depending on the received signal S1, the data processor 4 can undertake a corresponding action (i.e., vehicle unlocking and/or activation of one or more vehicle accessories).

Still another function comprises a “Pedestrian avoidance system”, whereby the data processor 4 can use the signals to detect pedestrians present in the vicinity of the vehicle V, and upon detection can take action (such as warning the driver, or having the vehicle perform a braking action or evading maneuver).

Further, the data processor 4 may be arranged, for instance, to provide a vehicle number plate shield, by having, during activation, signals S2 transmitted for a particular protection period, which disenable readability of a vehicle number plate.

A still further function, to be optionally performed, comprises a blind spot detection, whereby one or more optical passages 1 are positioned to receive optical signals from an area that is not directly visible to a driver of the vehicle V.

The data processor 4 may be configured, for instance, to perform only one of the above-mentioned tasks/functions, or to perform at least two of the tasks mentioned. The data processor 4 may, for instance, be switchable, via the interface 6, to different modes to perform the different available functions.

It is noted that during use, for instance, predetermined data, for instance, data stored in a database, can be used to associate the optical signals S1, S2 mutually. An extra advantageous elaboration comprises use of a neural network N, to associate such optical signals S1, S2 mutually.

FIGS. 7-9 show extra advantageous elaborations of optical systems to be used in the vehicle, comprising in particular further elaborations of the examples shown in FIGS. 1-6. The optical means shown in FIGS. 7-9 comprise, in particular, extra advantageous, efficient and relatively compact elaborations of proximal parts of the optical system, situated at a transmitter and/or receiver as mentioned.

As is represented in FIG. 7, the vehicle is preferably provided with an optical system, arranged to pass on light between the signal processing unit U and respective transmitter 3b (both schematically shown) and proximal ends of at least a number of the optical second signal guides 2b, the optical system comprising a first collimator 100 to collimate, in particular diverging, optical signals S2 coming from the transmitter 3b. The transmitter 3b is set up, in particular, in or near a focus of the collimator 100, such that the collimator can convert the diverging beam transmitted by the transmitter 3b into a substantially parallel beam (i.e., a substantially collimated beam). A focal distance of the first collimator corresponding to the collimator focus may, for instance, be relatively small, and be in the range of about 1-5 cm, for instance, about 1-2 cm, in order that a compact configuration can be obtained.

According to a further elaboration, the optical system comprises an array of optical elements 101, to divide signals collimated by the first collimator 100 into partial signals/partial beams S2a, S2b, S2c, and to pass on the partial signals to the proximal ends of the optical signal guides 2b. The optical elements 101a, 101b, 101c of the array may, for instance, be positioned next to each other, along a plane extending perpendicularly to the optical axis, or differently. Preferably, the optical elements 101 are so configured that a transmitter signal S2 is divided into partial signals S2a, S2b, S2c comprising approximately the same light power. To this end, the optical elements 101 can, for instance, separate mutually different power parts of the transmitter signal S2, in particular if the transmitter does not provide a homogeneous spatial radiation power characteristic (for instance, a transmitter that radiates relatively much power along the optical axis with respect to signal parts diverging from the optical axis).

According to an extra advantageous elaboration, the array of optical elements comprises an array of microlenses 101, in particular lenses each having each a maximum diameter of 1 cm, in particular 0.5 cm. In the example the microlenses 101 are positive lenses, the set-up being such that the proximal ends of the signal guides 2 are in or near foci of the respective lenses 101 (to effect signal coupling). A focal distance corresponding to these foci, of each optical element 101a, 101b, 101c of the array 101 can be, for instance, relatively small, and be in the range of about 1-5 cm, for instance, about 1-2 cm. As follows from the drawing, optical inputs of the proximal ends of the signal guides 2b face the optical system 100, 101. The inputs of the guides 2b can, for instance, coincide with optical axes of the respective optical elements 101a, 101b, 101c of the focusing array 101.

The drawing shows three microlenses 101a, 101b, 101c, associated with three respective signal guides 2b. Clearly, also a different number of microlenses may be provided, for instance, only one, or two, or at least four or five, depending on the number of signal guides 2 which optical partial signals are to be coupled into. Further, for instance, use can be made of reflecting focusing elements instead of microlenses 101, for instance, an array of micromirrors, to generate the partial signals S2a, S2b, S2c and pass them on to the proximal ends of the signal guides 2b.

The array of optical elements 101 may be manufactured, for instance, of (transparent) plastic. The array of elements 101 may, in particular, be manufactured relatively simply in one piece, for instance, in a plastic injection molding process or otherwise.

The optical elements 101 of the array may, for instance, be disposed near or against each other, and within a radius of at most 5 cm from an optical axis of the optical system, in particular a radius of at most 2 cm, for instance, a radius of at most 1 cm.

According to a further elaboration, the first collimator 100 can have a maximum diameter K1 of 5 cm, in particular 3 cm and more particularly 2 cm. In the example, the collimator 100 is a collimating (positive) lens. Alternatively, a collimating mirror may be used as collimator. Further, the first collimator 100 can have, for instance, a maximum thickness, measured on and parallel to the optical axis, of less than 1 cm, for instance, about 6 mm or less.

Each element of the array of optical elements 101 can be of relatively thin design, for instance, having a maximum thickness, measured parallel to the optical axis, of less than 1 cm, for instance, about 5 mm or less.

Further, the array of optical elements 101 may be disposed, for instance, at a relatively short distance K2 from the first collimator 100, for instance, a distance (measured parallel to the optical axis of the system) of at most 10 cm, more particularly at most 5 cm, and preferably a distance of about 1 cm or less.

Thus, a particularly compact configuration can be achieved. In a non-limitative example, the system 100, 101 is so configured that a maximum distance between the proximal ends of the signal guides 2b and the transmitter 3b, measured in a direction parallel to the optical axis of the system, is 10 cm, more particularly 7 cm, and is preferably in the range of 2-6 cm.

The optical system, comprising the first collimator 100 and the optical elements 101, may be positioned in different manners, for instance, by means of a holder frame, not represented, a common housing (not represented), or the like, for instance jointly with the transmitter 3b (and possibly with the associated optical processing unit U). Such a frame or housing may be provided, for instance, with coupling ports for receiving (and engaging) the proximal ends of the signal guides 2b, and, for instance, to position the ends mutually as well as with respect to the optical elements 101. In an extra advantageous elaboration, the coupling ports can detachably engage the proximal ends of the signal guides 2b, or form a blocking, detachable coupling therewith.

FIG. 8 shows a further elaboration of the optical system, concerning the transmission of optical signals S1. The system shown in FIG. 8 may, for instance, be combined with the transmitter configuration shown in FIG. 7, for instance, in a manner analogous to the implementations shown in FIGS. 1-3 or in a different manner.

In FIG. 8 the optical processing unit U is provided with at least a receiver 3a for reception of optical signals S1 passed on by at least a number of first signal guides 2a (see also FIGS. 1-5). It is then advantageous, according to an aspect of the invention, if an optical system 102, 103 is provided, to pass on diverging light beams S1 coming from proximal ends of the optical signal guides 2a to the receiver 3a, the optical system comprising a second collimator 102 to collimate diverging optical signals coming from optical signal guides 2a, and in particular also a focusing element 103 to focus the optical signals collimated by the second collimator 102 on the detector. In this manner also, a particularly compact and efficient configuration can be achieved, with relatively simple means

In the example, the proximal ends of the signal guides 2a are disposed near or against each other—with optical exits facing the optical system 102, 103—, preferably centrally on the optical axis of the system 102, 103. According to a further elaboration, the proximal ends may be arranged, for instance, in a closed stacking. The proximal ends may be relatively compact, and be located jointly, for instance, within a virtual circle having a diameter K3 which is less than 5 mm, in particular less than 2 mm, the circle being concentric with the optical axis of the system 102, 103.

In the example, the proximal ends of the signal guides 2a are arranged in or near a focus of the second collimator, to convert the signals S1 into a substantially parallel beam. This parallel beam is focused by the focusing element 103 on the receiver 3a; to that end, the receiver 3a may be positioned in or near a focus of that element 103.

In the example, the second collimator 102 and focusing element 103 are positive lenses; alternatively, for instance, reflecting optical elements may be used as second collimator and focusing element, or a combination of a lens and a reflector element.

The set-up shown in FIG. 8 may be of compact design, for instance, with a maximum distance between the proximal ends of the signal guides 2a and the receiver 3a, measured in a direction parallel to the optical axis of the system, of 10 cm, more particularly 7 cm, and preferably in the range of 2-6 cm. The two positive lenses of this example, viz., the collimator lens 102 and the focusing lens 103, may, for instance, be placed close to each other, for instance, at a distance of less than 5 cm, in particular a distance of less than 2 cm, for instance, about 1 cm or a shorter distance.

In a non-limiting example, a focal distance of the second collimator 102, corresponding to the collimator focus, can be, for instance, less than 5 cm, and, for instance, about 2 cm, or be less.

In a non-limiting example, a focal distance of the focusing element 103 (corresponding to the focusing element focus) can be, for instance, less than 5 cm, and, for instance, about 2 cm, or be less.

Just as in the example shown in FIG. 7, the parts shown in FIG. 8 can be mutually held in position in different manners. Positioning can be done by means of a holder frame, not represented, a common housing (not represented), or the like, for instance jointly with the receiver 3a (and possibly with the associated optical processing unit U). Such a frame or housing may be provided, for instance, with coupling ports for receiving (and engaging) the proximal ends of the signal guides 2a, and, for instance, to position those ends mutually as well as with respect to the optical elements 102, 103. Upon combination of the systems shown in FIGS. 7 and 8, the same housing or the same frame may be provided to keep the parts of the systems in position, and, for instance, to protect them against ambient influences.

FIG. 9 shows a further elaboration of the system shown in FIG. 7, in which a number of (in this case three) signal guides 2 are installed, both to send signals S2 to surroundings of the vehicle and to guide signals S1 incident upon the vehicle to a signal processing unit (analogously to the example shown in FIG. 4).

The configuration shown in FIG. 9 comprises, in addition to the elements shown in FIG. 7, a receiver 3a as well as optical means to direct signals (S1) coming from the proximal ends of the signal guides 2 to the receiver. These means comprise in particular the array of optical elements (for instance, microlenses as mentioned) 101, which have a double function. The array of optical elements 101 can primarily form partial beams from a signal sent by the transmitter 3b, which partial beams are led into the signal guides 2 to be transmitted via respective passages 1 out of the vehicle.

The array of optical elements 101 is furthermore available to collimate the diverging signals (S1) coming from the signal guides 2 (originating from surroundings and respective passages 1).

Further, a beam splitter 105 is provided, which is set up between the array of optical elements 101 and the first collimator 100, to direct the (incoming) signals, collimated by the optical elements 101, to the receiver 3a. In particular, a focusing element 103 is set up, for instance, a positive lens or alternatively a focusing mirror, between the beam splitter 105 and the receiver, to focus the collimated signals, deflected by the beam splitter, on the receiver 3a.

Preferably, a semi-transmitting beam splitter 105 is used as beam splitter, arranged for reflecting a part of optical signals—received via said passages 1—coming from the signal guides and element array 101. Such a beam splitter 105 can furthermore arrange for the beam generated by the transmitter 3b and respective first collimator 100 to be substantially (for instance for more than 50%, in particular more than 80%) passed on to the array of optical elements 101.

A relatively simple beam splitter 105 can comprise a flat transparent plate, for instance, a glass plate or a plastic plate of a transparent plastic, in particular having two substantially parallel optical side surfaces facing away from each other (respectively facing the first collimator 100 on one side and the array of elements 101 on the other). The plate 105 may be set up at a particular angle with respect to the optical axis of the system of collimator and array of elements. A normal to an optical surface of such a plate can include, for instance, an angle α in the range of 20-70 degrees with the optical axis of the first collimator 100 and the array of elements 101. The beam splitter 105 may be implemented, for instance, to reflect a relatively small part, for instance, at most 20%, and in particular at most 10%, of incident signals S1 (coming from the signal guides 2 and optical collimating element array 101), for reception by the receiver 3a. Such a beam splitter can pass, for instance, at least 80% of transmitted signals (S2) incident from the first collimator 100, in particular at least 90% of those signals, to the array of optical elements 101, for coupling into the signal guides 2.

The elements shown in FIG. 9 can provide a particularly compact system. Thus, for instance, a distance between the first collimator 100 and the transmitter 3b can be relatively small, and be in the range of about 1-5 cm, for instance, about 1-2 cm. A distance K5 between the first collimator 100 and an optical surface of the beam splitter 105, measured along the optical axis, may be, for instance, in the range of about 1-5 cm, for instance, about 2-3 cm. A distance K6 between an optical surface of the beam splitter 105 and the element array 101, measured along the optical axis, may be, for instance, in the range of about 1-5 cm, for instance, about 2-3 cm. A distance K7 between an optical surface of the beam splitter 105 and the focusing element 103, measured along the optical axis of that element 103, may be, for instance, in the range of about 1-5 cm, for instance about 2-3 cm. Finally, the distance K8 between the focusing element 103 and the receiver 3a, in a non-limiting example, may be less than 5 cm, being, for instance, 2 cm or less. Clearly, other distances between the various elements may be used as well.

The parts shown in FIG. 9 can be mutually held in position in different manners. Positioning can be done by means of a holder frame, not represented, a common housing (not represented), or the like, for instance jointly with the receiver 3a, the transmitter 3b (and possibly with the associated optical processing unit U). Such a frame or housing may be provided, for instance, with coupling ports for receiving (and engaging) the proximal ends of the signal guides 2a, and, for instance, to position those ends mutually as well as with respect to the various optical elements 100, 101, 103, 105. As mentioned, such a frame or housing may be provided with the coupling ports for receiving (and engaging) the proximal ends of the signal guides 2, and, for instance, to position those ends mutually as well as with respect to the optical elements 101. In an extra advantageous elaboration, the coupling ports may detachably engage the proximal ends of the signal guides 2, or form a blocking, detachable coupling therewith.

It will be understood that the invention is not limited to the exemplary embodiment described. Various modifications are possible within the scope of the invention as set forth in the appended claims.

Thus, the term “a(n)” in this application can mean only one, at least one, or a number of.

Further, a system as mentioned can be simply installed in different kinds of vehicles, including, e.g., a motor vehicle, automobile, motorcycle, truck, a part of a motor vehicle, trailer vehicles hauled by a motor vehicle, e.g., truck trailer or mobile home, and/or a combination thereof.

In addition, it will be clear that a vehicle may also be provided with an optical passage situated on a vehicle exterior for passing on optical signals, and a corresponding elongate optical signal guide 2, which extends between the passage 1 and at least an optical signal processing unit U situated in the vehicle, without use of an above-mentioned transmitter or receiver.

Further, the system may, for instance, be of modular construction, for instance, such that it can simply be expanded by addition of one or more optical signal guides. Further, a length of an optical signal guide may, for instance, be simply adapted to an available installation length. If a length of an optical signal guide is changed, it is preferred that the data processor 4 be provided with new (optional) information which is related to the length of the new optical signal guide (for instance, utilizing the interface 6).

Furthermore, an above-mentioned (preferably biconical) aperture angle adapter can be used, for instance, in a system that is not provided with the optical system with collimator. In such a case, there is provided a vehicle comprising:

at least an optical passage 1 situated at a vehicle exterior for passing on optical signals S1, S2;

a number of elongate optical signal guides 2, extending between the passage 1 and at least an optical signal processing unit U situated in the vehicle,

wherein the optical processing unit U is provided with a transmitter 3; 3b for transmission of optical signals S2;

wherein the optical passage is provided with an aperture angle adapter 11′ which is arranged to provide a horizontal aperture angle φ which is greater than a vertical aperture angle Ω.

Further, an aspect of this invention comprises a vehicle which has at least the following essential features:

at least an optical passage (1) situated at a vehicle exterior for passing on optical signals (S1, S2);

a number of elongate optical signal guides (2), extending between the passage (1) and at least an optical signal processing unit (U) situated in the vehicle,

wherein the optical processing unit (U) is provided with a receiver (3; 3a) for reception of optical signals (S1);

wherein an optical system is arranged to pass on light between the proximal ends of at least a number of the optical signal guides (2) and the signal processing unit (U), wherein the optical system comprises a collimator to collimate diverging optical signals coming from the signal guides (2).

In that case, use of a transmitter 3b and associated collimator 100 is optional.

Further, for instance, a modular configuration may be used. In that case, for instance, a number of light guides 2 with an associated array of optical elements 101 (for instance, microlenses) can be accommodated in a first module, while an above-mentioned transmitter 3b and first collimator are accommodated in a second module, whereby the first and second module can be joined together to provide a signal transmission system (such as shown, for instance, in FIG. 7). The second module mentioned may, for instance, be further provided with a detector 3a, beam splitter 105 and focusing element 103, in order that the further elaboration shown in FIG. 9 can be provided after joining the two modules together. Further, the second module comprises, for instance, the signal processing unit U.

Alternatively, for instance, a first module can comprise a guide module, provided with a number of transmitter light guides 2b with an above-mentioned array of optical elements 101 (for instance, microlenses), as well as a number of receiver light guides 2a with an associated second collimator 102. A transmitter 3b and first collimator 100 can then be accommodated in a second module, whereby the first and second module can be joined together to provide a signal transmission system (such as shown, for instance, in FIG. 7). Furthermore, a third module may then be provided, comprising a focusing element 103 and detector 3a, this third module being joinable together with the first module to form a detector system (as shown, for instance, in FIG. 8). In this manner, a relatively high reception sensitivity can be obtained. A signal processing unit U may, for instance, be provided separately from the second and third module, in a signal processing module, or be part of a such second and/or third module.

In each first module mentioned (i.e., signal guide-comprising module), preferably, also at least an optional aperture angle adapter 11, 11′ may already be provided, for instance (but not limited to) a biconical lens. Further, it is preferred that both the array of optical elements 101 and such an optional aperture angle adapter 11, 11′ of the module are made of plastic.

1. A vehicle, provided with:
at least an optical passage situated at a vehicle exterior for passing on optical signals;
a number of elongate optical signal guides, extending between said passage and at least an optical signal processing unit situated in the vehicle,
wherein the optical processing unit is provided with a transmitter for transmission of diverging optical signals;
wherein an optical system is arranged to pass on light between the signal processing unit and proximal ends of at least a number of the optical signal guides, wherein the optical system comprises a collimator to collimate optical signals coming from the transmitter.

2. A vehicle according to claim 1, wherein the optical system comprises an array of optical elements, to divide signals collimated by the collimator into partial signals, and to pass on the partial signals to the proximal ends of the optical signal guides.

3. A vehicle according to claim 2, wherein the array of optical elements comprises an array of microlenses, in particular, lenses having a maximum diameter of 1 cm, in particular 0.5 cm.

4. A vehicle according to claim 2, wherein the array of optical elements is manufactured of plastic.

5. A vehicle according to claim 2, wherein the optical elements of the array are disposed near or against each other, and within a radius of at most 5 cm from an optical axis of the optical system, in particular a radius of at most 2 cm, for instance, a radius of at most 1 cm.

6. A vehicle according to claim 1, wherein said collimator has a maximum diameter of 5 cm, in particular 3 cm and more particularly 2 cm.

7. A vehicle according to claim 1, wherein said collimator is a collimating lens or collimating mirror.

8. A vehicle according to claim 1, wherein the optical processing unit is provided with at least a receiver for reception of optical signals passed on by at least a number of said signal guides.

9. A vehicle according to claim 8, provided with an optical system to pass on light coming from proximal ends of the optical signal guides to the receiver, wherein the optical system comprises a second collimator to collimate optical signals coming from optical signal guides, and in particular also a focusing element to focus the optical signals collimated by the second collimator on the detector.

10. A vehicle according to claim 9, wherein the second collimator comprises an array of optical collimating elements.

11. A vehicle according to claim 9, wherein the optical system comprises a semi-transmitting beam splitter, preferably disposed between the second collimator and the proximal ends of the signal guides, arranged for deflecting optical signals coming from the signal guides.

12. A vehicle according to claim 11, wherein the beam splitter comprises a glass plate or plastic plate.

13. A vehicle according to claim 1, wherein the transmitter, for the purpose of transmission of diverging optical signals, comprises at least one laser diode, and preferably only one laser diode.

14. A vehicle according to claim 1, wherein said diverging optical signals comprise infrared optical signals.

15. A vehicle according to claim 1, wherein each said signal guide is an elongate flexible signal guide, in particular comprising at least an optical fiber, and preferably has a length of more than about 0.5 m, for instance, at least about 1 m.

16. A vehicle according to claim 1, wherein said optical passage is associated with an aperture angle adapter which is arranged to provide a horizontal aperture angle that is greater than a vertical aperture angle.

17. A vehicle, for instance a vehicle according to claim 1, provided with:
at least an optical passage situated at a vehicle exterior for passing on optical signals;
a number of elongate optical signal guides, extending between said passage and at least an optical signal processing unit situated in the vehicle,
wherein the optical processing unit is provided with a receiver for reception of optical signals;
wherein an optical system is arranged to pass on light between the proximal ends of at least a number of the optical signal guides and the signal processing unit, wherein the optical system comprises a collimator to collimate diverging optical signals coming from the signal guides.

18. A set, comprising a number of elongate optical signal guides, an optical processing unit and an optical system, apparently intended and suitable for use in a vehicle according to claim 1.
